(19) United States
(12) Patent Application Publication
(10) Pub. No.: US 2012/0012071 A1
(43) Pub. Date: Jan. 19, 2012

(54) PET LEASH

(76) Inventor: Troy Anthony Hinojosa, Corpus Christi, TX (US)

(21) Appl. No.: 12/884,055

(22) Filed: Sep. 16, 2010

Related U.S. Application Data
(60) Provisional application No. 61/364,106, filed on Jul. 14, 2010.

(51) Int. Cl. A01K 27/00; A44B 99/00

(52) U.S. Cl. 119/795; 24/265 R

(57) ABSTRACT

A pet leash includes a hollow handle, an elongated member adapted to pass through the hollow handle, and a fastener connected to each one of the ends of the elongated member. The pet leash allows an individual to walk two pets and at the same time be able to hold and control the animals, preventing the tangling of the leashes.

### CROSS-REFERENCE TO RELATED APPLICATIONS

This application claims the benefit of Provisional Application No. 61/364,106 filed Jul. 14, 2010, the contents of which are incorporated herein by reference.

### BACKGROUND OF THE INVENTION

The present invention generally relates to a pet leash. More specifically, the present invention relates to a pet leash that allows an individual to walk two pets at the same time.

Leashes have been used in walking dogs and other animals to hold, control, and otherwise secure the animal. Unfortunately, walking two pets at the same time often leads to having the pet owner tangled up, tripped, leash-burned, being pulled in two different directions, or the dogs becoming entangled.

As can be seen, there is a need for a pet leash that allows an individual to walk two pets and at the same time be able to hold and control the animals, preventing the tangling of the leashes.

### SUMMARY OF THE INVENTION

In one aspect of the present invention, the pet leash includes a hollow handle, an elongated member adapted to pass through the hollow handle, and a fastener connected to each one of the ends of the elongated member.

In another aspect of the present invention, the pet leash includes a hollow handle, an elongated member adapted to pass through the hollow handle, a fastener connected to each one of the ends of the elongated member, and a stopper located between each one of the ends of the hollow handle and the corresponding fastener.

These and other features, aspects and advantages of the present invention will become better understood with reference to the following drawings, description and claims.

### BRIEF DESCRIPTION OF THE DRAWINGS

FIG. 1 illustrates a perspective front view of a pet leash according to an exemplary embodiment of the present invention;

FIG. 2 illustrates a detailed section view of the pet leash of FIG. 1;

FIG. 3 illustrates a detailed section view of the pet leash of FIG. 1 showing the leash in a working position;

FIG. 4A illustrates a perspective front view of a pet leash according to an alternate embodiment of the present invention;

FIG. 4B illustrates a perspective front view of a pet leash according to an alternate embodiment of the present invention; and

FIG. 4C illustrates a perspective front view of a pet leash according to an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a pet leash that allows an individual to walk two pets at the same time without the tangling of the leashes.

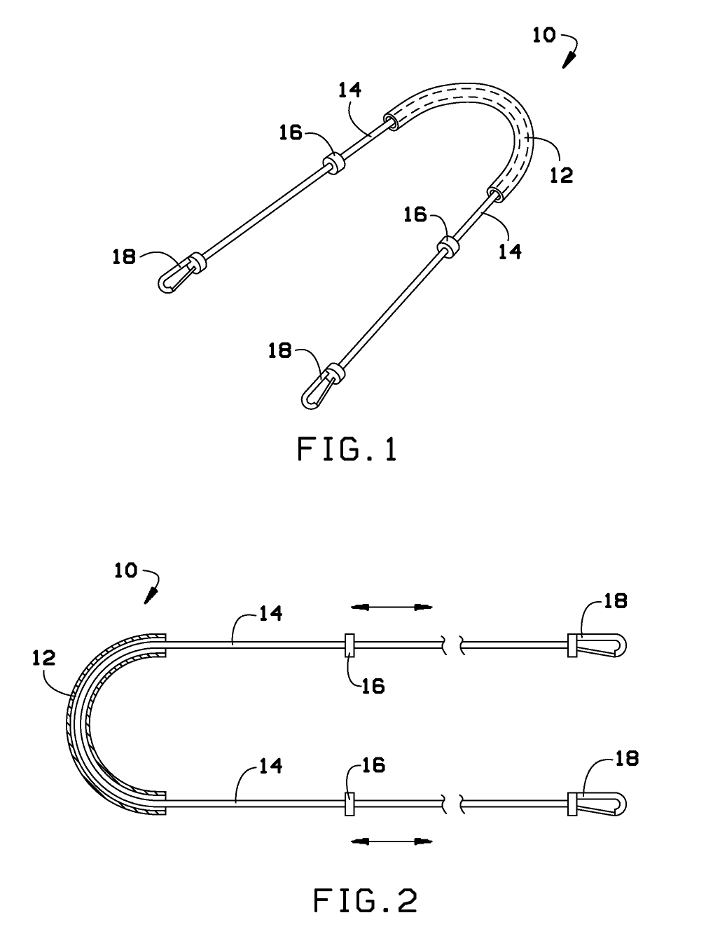

FIGS. 1 and 2 show a pet leash 10 according to an exemplary embodiment of the present invention. The pet leash 10 may include a hollow handle 12, an elongated member 14 passing through the hollow handle 12, and fasteners 18 located on each end of the elongated member 14. In addition, the pet leash 10 may include a stopper 16 placed between any point along the elongated member 14 and the end of the hollow handle 12. In one embodiment, the pet leash 10 may include a stopper 16 at each one of the hollow handle 12.

The hollow handle 12 may be made of a strong moldable material. In one embodiment, the hollow handle 12 may be made of rubber, plastic, metal, or wood. The hollow handle 12 may have a circumference shape. The circumference shape may be round, oval, square, octagonal, pentagonal, triangular, or hexagonal. In one embodiment, the outside surface of the hollow handle 12 may include decorations. In one embodiment, the decorations may be stickers or letters. In one embodiment, the hollow handle 12 may have a smooth inner surface. The length of the hollow handle 12 may depend on the customer's requirement. In one embodiment, the hollow handle 12 may have a length of approximately 36 inches. The inside diameter of the hollow handle 12 may depend on the customer's requirement. In one embodiment, the hollow handle 12 may have a diameter of approximately 1-⅜ inches.

The hollow handle 12 may include a cover. In addition, the cover may have a gripping surface. In one embodiment, the cover may be made of a soft material. In one embodiment, the cover may be made of a non-slip material. The outer surface of the hollow handle 12 may include a non-slip surface. In one embodiment, the non-slip surface may be produce by milling, chemical etching, machining, or brushing.

In one embodiment, the hollow handle 12 may include a bend. In one embodiment, the hollow handle 12 may include at least one curve. In one embodiment, the hollow handle 12 may be a straight handle. In one embodiment, the hollow handle 12 may be formed into a U-shape. In one embodiment, the hollow handle 12 may be formed into a V-shape (FIG. 4A), an M-shape or a W-shape (FIG. 4B), or a serpentine-shape (FIG. 4C). In one embodiment, the hollow handle 12 may be formed into an S-shape.

The elongated member 14 may be made of a strong material that allows restraining two pets without breaking. In one embodiment, the elongated member 14 may be a rope, a chain, a cable, or a cord. In one embodiment, the elongated member 14 may be a nylon rope. The length of the elongated member 14 may depend on the customer's requirement. In one embodiment, the elongated member 14 may have a length of approximately 20 feet.

In addition, the pet leash 10 may include a stopper 16 placed between any point along the elongated member 14 and the end of the hollow handle 12. In one embodiment, the pet leash 10 may include a stopper 16 at each one of the hollow handle 12. The stopper 16 may have a surface area larger than the surface area of the ends of the hollow handle 12 to prevent the stopper 16 from passing thru the hollow handle 12. In one embodiment, the stopper 16 may include a hole to allow the elongated member 14 to slide through. In one embodiment, the stopper 16 may include a slot to allow the stopper 16 to be inserted or removed from the elongated member 14 as required by the user. The stopper 18 may be made of wood, metal, glass, or plastic. The stopper 16 may have a variety of shapes. In one embodiment, the stopper 16 may be a cylinder, a square, a triangle, a sphere, a star, or a flower. The stopper 16 may be placed at any point along the elongated member between the end of the hollow handle 12 and the end of the elongated member 14. In one embodiment, the position of the stopper through the elongated member 12 may be adjustable. In one embodiment, the stopper 16 may be interchangeable.

In one embodiment, the pet leash 10 may not include the stoppers 16.

The pet leash 10 may include a fastener 18 attached to each end of the elongated member 14 to attach the pet leash 10 into the pet's collar. In one embodiment, the fastener 18 may be a clasp, a buckle, or a hook.

The pet leash 10 may be configured to walk only one dog by placing the two fasteners on the same dog.

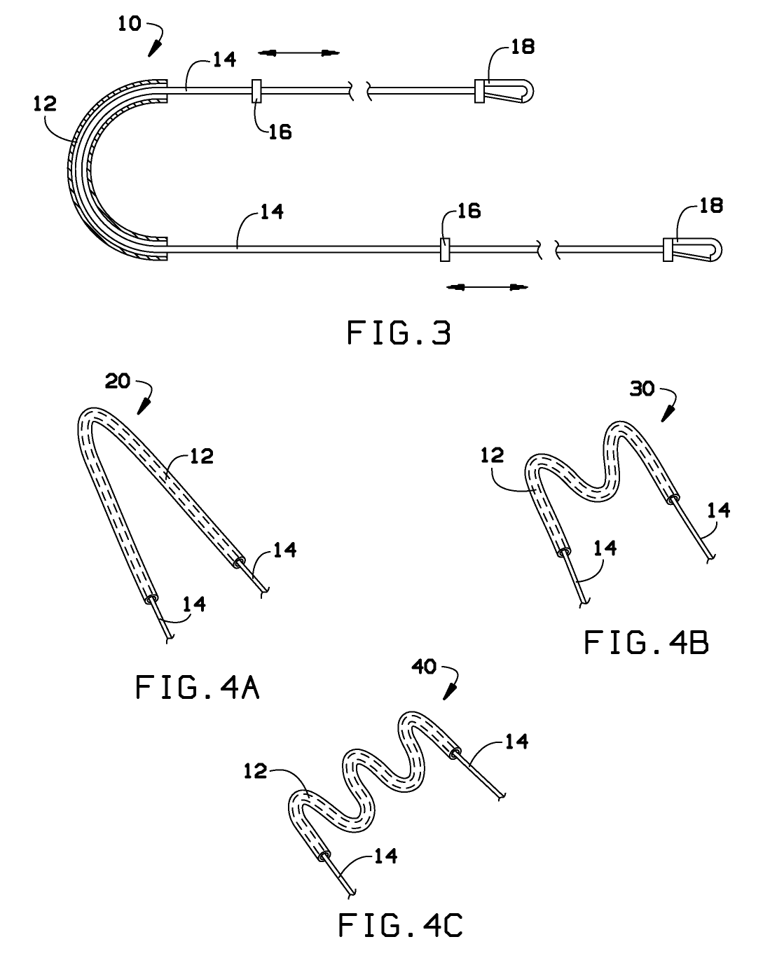

FIG. 3 illustrates a detailed section view of the pet leash of FIG. 1 showing the pet leash 10 in a working position. Basically, the pets may pull the ends of the pet leash 10 against each other as the elongated member 14 slides through the hollow handle 12.

Basically, the elongated member 14 may be run through the hollow handle 12 until obtaining equal lengths of the elongated member 14 extending out each end of the hollow handle 12. Then, a fastener 18 may be placed at each end of the elongated member 14. Optionally, the user may add stoppers 16 at a desired location of the elongated member 14 between the fastener 18 and the hollow handle 12. Then, the user may fasten a pet into each one of the fasteners 18.

The user may walk two pets at the same time. The pets may pull against each other as the elongated member 14 slides through the hollow handle 12 and not against the user walking the dogs. The pet leash 10 may offer excellent control of both pets, without tangling the elongated member 14.

It should be understood, of course, that the foregoing relates to exemplary embodiments of the invention and that modifications may be made without departing from the spirit and scope of the invention as set forth in the following claims.

We claim:

1. A pet leash comprising:
a hollow handle;
an elongated member adapted to pass through the hollow handle, the elongated member having a first end and a second end; and
a fastener connected to each one of the ends of the elongated member.

2. The pet leash according to claim 1, wherein the elongated member further comprises a stopper.

3. The pet leash according to claim 1, wherein the hollow handle includes a curve or a bend.

4. The pet leash according to claim 3, wherein the shape of the hollow handle is selected from the group consisting of a U-shape, a V-shape an M-shape, a W-shape, a serpentine-shape, and an S-shape.

5. The pet leash according to claim 1, wherein the elongated member is a rope, a chain, a cable, or a cord.

6. The pet leash according to claim 1, wherein the fastener is a clasp, a buckle, or a hook.

7. A pet leash comprising:
a hollow handle, the handle having a first end and a second end;
an elongated member adapted to pass through the hollow handle, the elongated member having a first end, a second end, and a length;
a fastener connected to each one of the ends of the elongated member;
a stopper located between each one of the ends of the hollow handle and the corresponding fastener.

8. The pet leash according to claim 7, wherein the stoppers are made of wood, metal, glass, or plastic.

9. The pet leash according to claim 7, wherein the stoppers are interchangeable.

10. The pet leash according to claim 7, wherein the position of the stoppers through the length of the elongated member is adjustable.
